(19) United States
(12) Patent Application Publication
(10) Pub. No.: US 2025/0337208 A1
(43) Pub. Date: Oct. 30, 2025

(54) Unlocking Tool and Method For Pulling Out Cable Assembly

(71) Applicants: SIBAS Electronics (Xiamen) Co. Ltd., Xiamen City (CN); Tyco Electronics (Shanghai) Co., Ltd., Shanghai (CN)

(72) Inventors: Guoqiang (David) Li, Shanghai (CN); Liqiang (Gino) Yao, Shanghai (CN); Yong (Chris) Wang, Shanghai (CN); Yong Yang, Shanghai (CN); Yuquan (Kenny) Chen, Shanghai (CN); Qiang Yuan, Xiamen (CN)

(73) Assignees: SIBAS Electronics (Xiamen) Co. Ltd., Xiamen City (CN); Tyco Electronics (Shanghai) Co., Ltd., Shanghai (CN)

(21) Appl. No.: 19/189,384

(22) Filed: Apr. 25, 2025

(30) Foreign Application Priority Data
Apr. 25, 2024 (CN) 202410511231.2

(51) Int. Cl. H01R 43/22

(52) U.S. Cl. CPC H01R 43/22

(57) ABSTRACT

An unlocking tool includes a first tool half and a second tool half. The first tool half has a first half cylinder portion and a first mounting portion each at a different end of the first tool half, and a first connecting portion connected between the first half cylinder portion and the first mounting portion. The second tool half has a second half cylinder portion and a second mounting portion each at a different end of the second tool half, and a second connecting portion connected between the second half cylinder portion and the second mounting portion. The first mounting portion and the second mounting portion are rotatably connected together such that the first tool half and the second tool half are rotatably opened and closed. The first half cylinder portion and the second half cylinder portion are combined into a cylindrical end portion when the first tool half and the second tool half are closed. The cylindrical end portion is fitted onto a cable of a cable assembly and is inserted into a mounting hole in a connector housing of a connector to simultaneously push a plurality of locking springs of the connector housing engaged with a terminal of the cable assembly to an unlocking position separated from the terminal, so that the cable assembly and the unlocking tool can be pulled out of the connector housing together.

### CROSS-REFERENCE TO RELATED APPLICATION

This application claims the benefit of the filing date under 35 U.S.C. § 119(a)-(d) of Chinese Patent Application No. CN202410511231.2 filed on Apr. 25, 2024.

### FIELD OF THE INVENTION

The present invention relates to a tool and, more particularly, to an unlocking tool and a method for pulling out a cable assembly from a connector housing with the unlocking tool.

### BACKGROUND OF THE INVENTION

In the prior art, a connector typically includes a connector housing and a cable assembly. The cable assembly includes a cable and a terminal fixed to the end of the cable. The terminal of the cable assembly is inserted into the mounting hole of the connector housing. Multiple locking springs are provided in the connector housing, which are engaged with the terminal of the cable assembly to lock the terminal of the cable assembly in the connector housing. When it is necessary to pull out the cable assembly from the connector housing, it is necessary to use an unlocking tool to simultaneously push multiple locking springs inside the connector housing to the unlocking position where they are detached from the terminal of the cable assembly. In the prior art, the unlocking tool typically includes two semi-circular cylindrical components that can be fastened together to form a complete cylindrical component. However, the unlocking tool requires two hands to operate simultaneously, which is inconvenient to use.

### SUMMARY OF THE INVENTION

An unlocking tool includes a first tool half and a second tool half. The first tool half has a first half cylinder portion and a first mounting portion each at a different end of the first tool half, and a first connecting portion connected between the first half cylinder portion and the first mounting portion. The second tool half has a second half cylinder portion and a second mounting portion each at a different end of the second tool half, and a second connecting portion connected between the second half cylinder portion and the second mounting portion. The first mounting portion and the second mounting portion are rotatably connected together such that the first tool half and the second tool half are rotatably opened and closed. The first half cylinder portion and the second half cylinder portion are combined into a cylindrical end portion when the first tool half and the second tool half are closed. The cylindrical end portion is fitted onto a cable of a cable assembly and is inserted into a mounting hole in a connector housing of a connector to simultaneously push a plurality of locking springs of the connector housing engaged with a terminal of the cable assembly to an unlocking position separated from the terminal, so that the cable assembly and the unlocking tool can be pulled out of the connector housing together.

### BRIEF DESCRIPTION OF DRAWINGS

The invention will now be described by way of example with reference to the accompanying figures, of which:

FIG. 1 is a perspective view of an unlocking tool, according to an exemplary embodiment, in an open position;

FIG. 2 is a perspective view of the unlocking tool of FIG. 1 in a closed position;

FIG. 3 is an exploded view of the unlocking tool of FIG. 1 when viewed from one side;

FIG. 4 is an exploded view of the unlocking tool of FIG. 1 when viewed from the other side;

FIG. 5 is a longitudinal sectional view of the unlocking tool of FIG. 1;

FIG. 6 is a plan view of a connector according to an exemplary embodiment;

FIG. 7 is a plan view of fitting the unlocking tool of FIG. 1 onto a cable assembly and inserting the unlocking tool toward a connector housing of the connector of FIG. 6;

FIG. 8 is a plan view of inserting a cylindrical end portion of the unlocking tool of FIG. 1 into a mounting hole of the connector housing of FIG. 7; and

FIG. 9 is a plan view of pulling the unlocking tool of FIG. 1 and the cable assembly of FIG. 7 together from the connector housing of FIG. 7.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

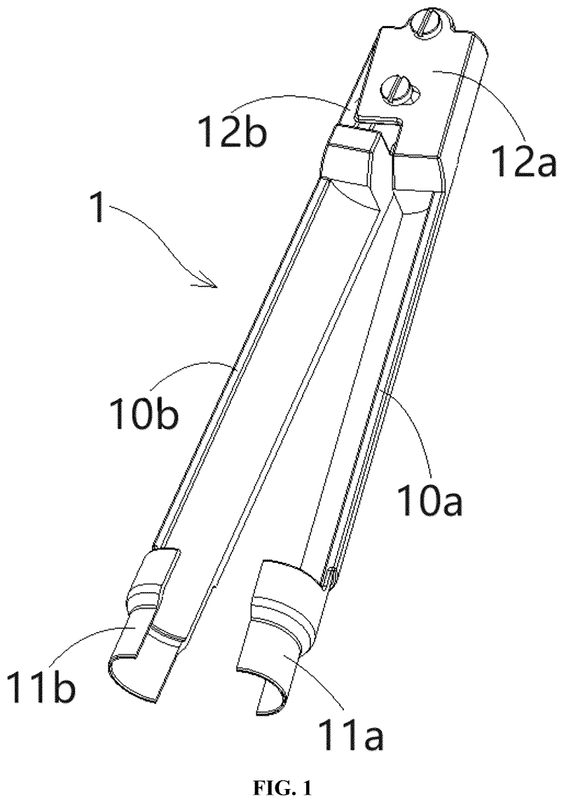

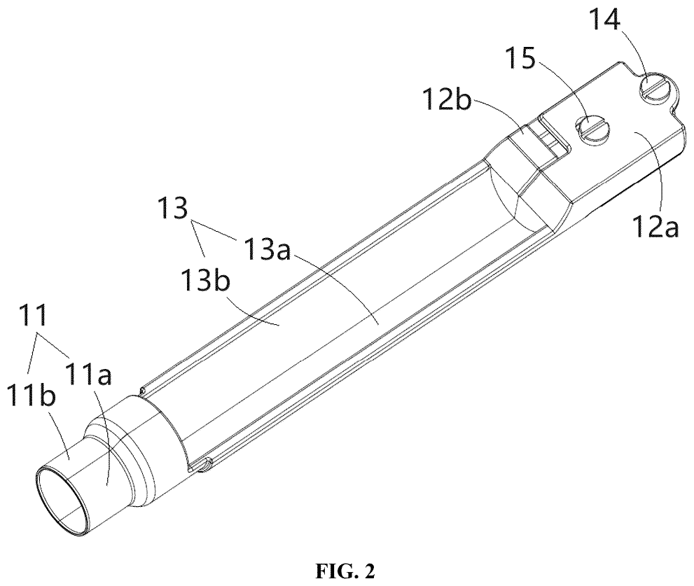

An exemplary embodiment of an unlocking tool 1 is now described with reference to FIGS. 1-9. As shown in FIGS. 1-3, the unlocking tool 1 includes a first tool half 10a and a second tool half 10b. The first tool half 10a includes a first half cylinder portion 11a and a first mounting portion 12a respectively located at both ends thereof. In other words, the first tool half 10a has the first half cylinder portion 11a and the first mounting portion 12a each located at a different end of the first tool half 10a. The first tool half 10a also includes a first connecting portion 13a, as shown in FIGS. 2-5, connected between the first half cylinder portion 11a and the first mounting portion 12a. The second tool half 10b includes a second half cylinder portion 11b and a second mounting portion 12b respectively located at both ends thereof. In other words, the second tool half 10b has a second half cylinder portion 11b and a second mounting portion 12b each located at a different end of the second tool half 10b. The second tool half 10b also includes a second connecting portion 13b, as shown in FIGS. 2-4, connected between the second half cylinder portion 11b and the second mounting portion 12b.

As shown in FIG. 1, the first mounting portion 12a and the second mounting portion 12b are rotatably connected together, allowing the first tool half 10a and the second tool half 10b to be rotatably opened and closed. As shown in FIG. 2, the first half cylinder portion 11a and the second half cylinder portion 11b are combined into a hollow cylindrical end portion 11 when the first tool half 10a and the second tool half 10b are closed.

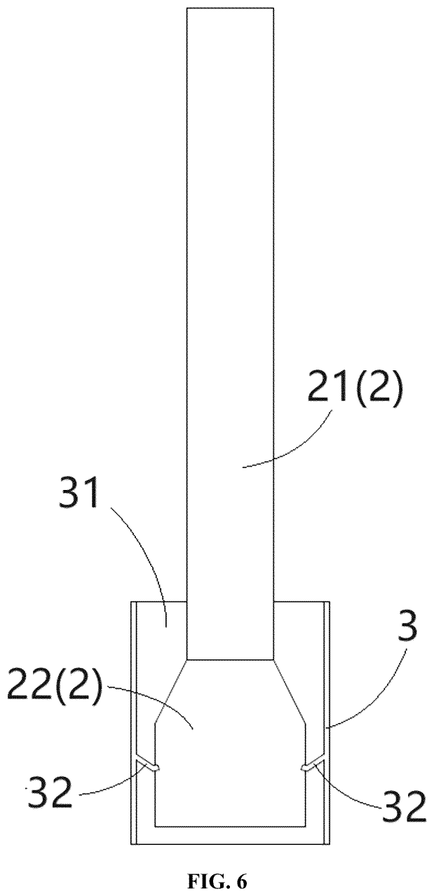

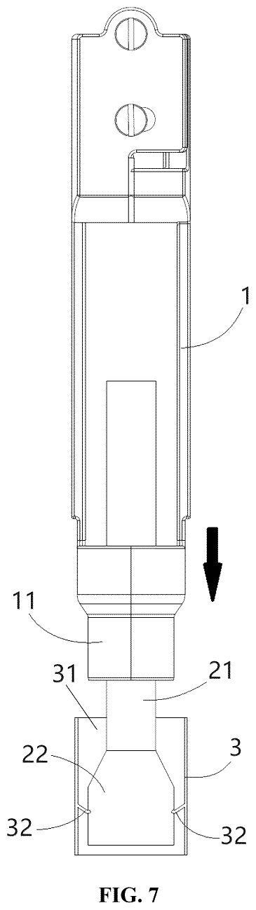

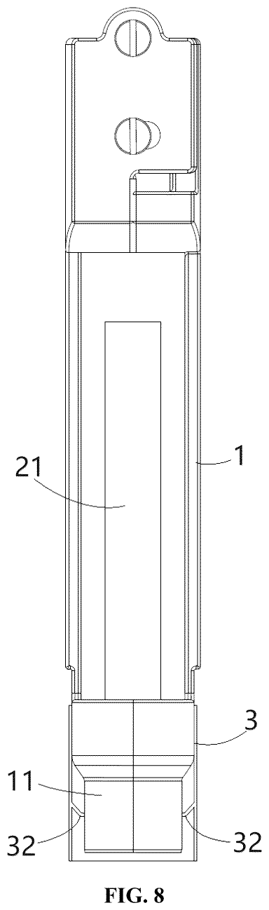

As shown in FIGS. 7-8, the cylindrical end portion 11 of the unlocking tool 1 is adapted to be fitted onto the cable 21 of the cable assembly 2, as shown in FIG. 6, and is adapted to be inserted into the mounting hole 31 of a connector housing 3 of a connector, as further shown in FIG. 6, to simultaneously push the multiple locking springs 32 engaged with the terminal 22 of the cable assembly 2 to the unlocking position separated from the terminal 22, so that the cable assembly 2 can be pulled out together with the unlocking tool 1.

As shown in FIG. 2, when the first tool half 10a and the second tool half 10b are closed, the side edges of the first half cylinder portion 11a and the second half cylinder portion 11b are in contact with each other, so that the first half cylinder portion 11a and the second half cylinder portion 11b are combined into a complete cylindrical end portion 11.

However, the present invention is not limited to the illustrated embodiment. For example, in another exemplary embodiment, when the first tool half 10a and the second tool half 10b are closed, the side edges of the first half cylinder portion 11a and the second half cylinder portion 11b are not in contact, and there is a predetermined gap between them, and the width of the predetermined gap in the circumferential direction of the cylindrical end portion 11 is smaller than the width of the locking spring 32 in the circumferential direction. This another exemplary embodiment can prevent interference problems caused by manufacturing errors.

As shown in FIG. 2, in the illustrated embodiment, when the first tool half 10a and the second tool half 10b are closed, the first connecting portion 13a and the second connecting portion 13b are combined into a semi cylindrical body 13 with an open side, so that the semi cylindrical body 13 and the cable 21 accommodated in the semi cylindrical body 13 (e.g., see FIGS. 7-9) can be simultaneously clamped with one hand, and the unlocking tool 1 and the cable assembly 2 can be pulled out together with one hand.

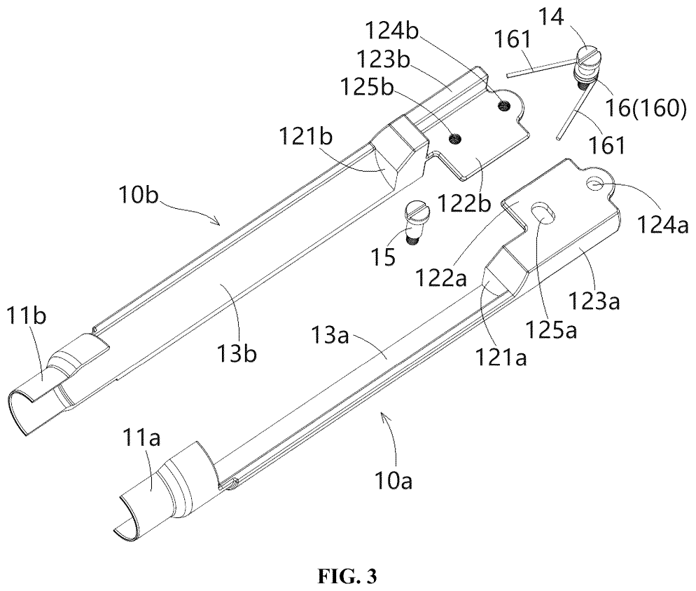

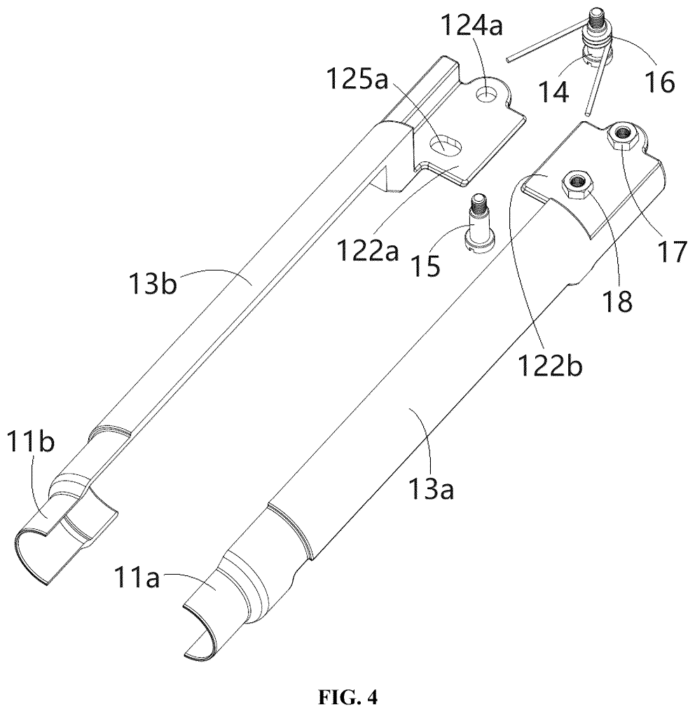

As shown in FIGS. 3-4, the first connecting portion 13a and the second connecting portion 13b are each in the shape of a quarter cylinder, allowing them to be combined into a semi cylindrical body 13.

As shown in FIG. 3, the first mounting portion 12a includes a first end plate 121a connected to the end of the first connecting portion 13a and a first horizontal plate 122a connected to the first end plate 121a. The second mounting portion 12b includes a second end plate 121b connected to the end of the second connecting portion 13b, and a second horizontal plate 122b connected to the second end plate 121b. The first horizontal plate 122a and the second horizontal plate 122b are spaced apart and opposite to each other and are rotatably connected, so that the first tool half 10a and the second tool half 10b can be opened and closed by rotation.

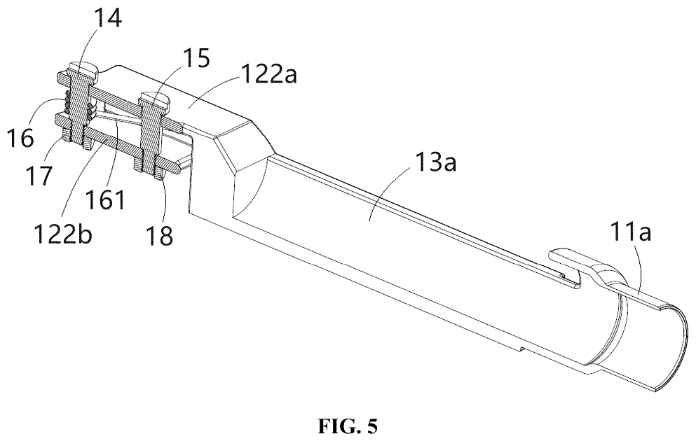

As shown in FIGS. 2-5, the unlocking tool 1 further includes a first bolt 14. As shown in FIG. 5, the first bolt 14 passes through the first horizontal plate 122a and is threaded with the second horizontal plate 122b, so that the first tool half 10a can rotate relative to the second tool half 10b around the first bolt 14.

As shown in FIGS. 3, a pivot hole 124a suitable for rotatably mating with a smooth rod portion of the first bolt 14 is formed in the first horizontal plate 122a, and a first threaded hole 124b suitable for threaded connection with a threaded portion of the first bolt 14 is formed in the second horizontal plate 122b.

As shown in FIG. 4, the unlocking tool 1 further comprises a first nut 17, which is arranged on the outer side of the second horizontal plate 122b facing away from the first horizontal plate 122a, for threaded connection with the end of the first bolt 14. As shown in FIG. 5, the head of the first bolt 14 is pressed against the outer side of the first horizontal plate 122a facing away from the second horizontal plate 122b, and the end of the first bolt 14 is exposed from the outer side of the second horizontal plate 122b and threaded with the first nut 17.

As shown in FIG. 3, a limit hole 125a that is elongated is formed in the first horizontal plate 122a, and a second threaded hole 125b is formed in the second horizontal plate 122b. The unlocking tool 1 also includes a second bolt 15, as shown in FIGS. 2-5, which passes through the limit hole 125a and is threaded with the second threaded hole 125b. The second bolt 15 can move between the two ends of the limit hole 125a, allowing the first tool half 10a to rotate relative to the second tool half 10b within a predetermined angle range.

When the first tool half 10a and the second tool half 10b are opened, as shown in FIG. 1, the inner wall surface of one end of the limit hole 125a is pressed against the second bolt 15 to restrict the first tool half 10a and the second tool half 10b to the predetermined open position.

As shown in FIG. 1, when the first tool half 10a and the second tool half 10b are in the predetermined open position, the opening angle between the first tool half 10a and the second tool half 10b is not greater than 20 degrees.

As shown in FIG. 3, the limit hole 125a is located between the first end plate 121a and the pivot hole 124a, and the second threaded hole 125b is located between the second end plate 121b and the first threaded hole 124b.

As shown in FIG. 4, the unlocking tool 1 further comprises a second nut 18, which is provided on the outer side of the second horizontal plate 122b facing away from the first horizontal plate 122a, for threaded connection with the end of the second bolt 15. As shown in FIG. 5, the head of the second bolt 15 is pressed against the outer side of the first horizontal plate 122a facing away from the second horizontal plate 122b, and the end of the second bolt 15 is exposed from the outer side of the second horizontal plate 122b and threaded with the second nut 18.

As shown in FIGS. 3-5, the unlocking tool 1 further comprises a reset torsion spring 16. The reset torsion spring 16 is installed between the first mounting portion 12a and the second mounting portion 12b for resetting the first tool half 10a and the second tool half 10b to the predetermined open position.

As shown in FIG. 3, the first mounting portion 12a further includes a first vertical plate 123a connected to one side of the first horizontal plate 122a and the first end plate 121a, and the second mounting portion 12b further includes a second vertical plate 123b connected to one side of the second horizontal plate 122b and the second end plate 121b. The first vertical plate 123a and the second vertical plate 123b are spaced apart from each other. As shown in FIGS. 3 and 5, a spiral body 160 of the reset torsion spring 16 is fitted onto the first bolt 14 and located between the first horizontal plate 122a and the second horizontal plate 122b. Two torsion arms 161 of the reset torsion spring 16 are respectively pressed against the inner sides of the first vertical plate 123a and the second vertical plate 123b.

In the aforementioned exemplary embodiments according to the present invention, the unlocking tool 1 has a simple structure, is easy to use, and can pull the cable assembly 2 out of the connector housing 3 with a single hand.

An exemplary embodiment of a method for unplugging a cable assembly is now described with references to FIGS. 7-9.

The method of unplugging the cable assembly includes a step S10: Providing the aforementioned unlocking tool 1.

The method of unplugging the cable assembly further includes a step S20: Grasping the unlocking tool 1 in the open position with one hand and move it towards the cable 21 of the cable assembly 2, so that the cable 21 of the cable assembly 2 enters between the first half cylinder portion 11a and the second half cylinder portion 11b of the unlocking tool 1.

As shown in FIG. 7, the method of unplugging the cable assembly also includes a step S30: Grasping the first connecting portion 13a and the second connecting portion 13b of the unlocking tool 1 tightly with one hand, so that the unlocking tool 1 is rotated from the open position to the closed position.

As shown in FIG. 8, the method of unplugging the cable assembly additionally includes a step S40: Inserting the cylindrical end portion 11 of the unlocking tool 1 into the mounting hole 31 in the connector housing 3, so as to simultaneously push the multiple locking springs 32 inside the connector housing 3 to the unlocking position separated from the terminal 22 of cable assembly 2 through the cylindrical end portion 11.

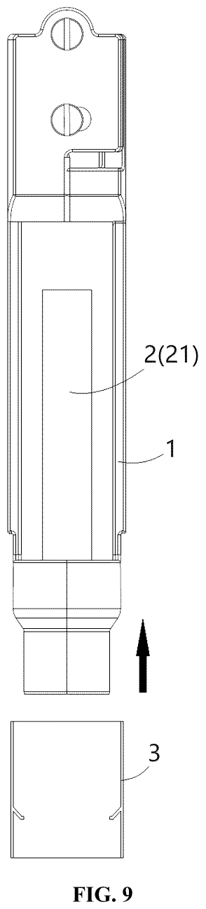

As shown in FIG. 9, the method of unplugging the cable assembly further includes a step S50: Clamping the semi cylindrical body 13 of unlocking tool 1 and the cable 21 with one hand and pull out the unlocking tool 1 and the cable assembly 2 outward at the same time, in order to pull out the unlocking tool 1 and the cable assembly 2 together from connector housing 3.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. An unlocking tool, comprising:
a first tool half having a first half cylinder portion and a first mounting portion each at a different end of the first tool half, and a first connecting portion connected between the first half cylinder portion and the first mounting portion; and
a second tool half having a second half cylinder portion and a second mounting portion each at a different end of the second tool half, and a second connecting portion connected between the second half cylinder portion and the second mounting portion, the first mounting portion and the second mounting portion are rotatably connected together such that the first tool half and the second tool half are rotatably opened and closed, and the first half cylinder portion and the second half cylinder portion are combined into a cylindrical end portion when the first tool half and the second tool half are closed, the cylindrical end portion is fitted onto a cable of a cable assembly and is inserted into a mounting hole in a connector housing of a connector to simultaneously push a plurality of locking springs engaged with a terminal of the cable assembly to an unlocking position separated from the terminal, so that the cable assembly and the unlocking tool can be pulled out of the connector housing together.

2. The unlocking tool of claim 1, wherein when the first tool half and the second tool half are closed, a side edge of the first half cylinder portion and a side edge of the second half cylinder portion are in contact with each other, so that the first half cylinder portion and the second half cylinder portion are combined into the cylindrical end portion.

3. The unlocking tool of claim 1, wherein when the first tool half and the second tool half are closed, a side edge of the first half cylinder portion and a side edge of the second half cylinder portion are not in contact such that there is a predetermined gap between the side edge of the first half cylinder portion and the side edge of the second half cylinder portion, a width of the predetermined gap in a circumferential direction of the cylindrical end portion is smaller than a width of one locking spring in the circumferential direction.

4. The unlocking tool of claim 1, wherein when the first tool half and the second tool half are closed, the first connecting portion and the second connecting portion are combined into a semi cylindrical body with an open side allowing the unlocking tool and the cable assembly to be pulled out of the connector housing together with one hand by simultaneously clamping the semi cylindrical body and the cable accommodated in the semi cylindrical body with one hand.

5. The unlocking tool of claim 4, wherein the first connecting portion and the second connecting portion each have a quarter cylindrical shape.

6. The unlocking tool of claim 1, wherein the first mounting portion has a first end plate connected to an end of the first connecting portion and a first horizontal plate connected to the first end plate, and the second mounting portion has a second end plate connected to an end of the second connecting portion and a second horizontal plate connected to the second end plate, the first horizontal plate and the second horizontal plate are spaced apart, opposite each other, and rotatably connected together allowing the first tool half and the second tool half to be opened and closed by rotation.

7. The unlocking tool of claim 6, further comprising a first bolt passing through the first horizontal plate and threaded with the second horizontal plate, the first bolt allows the first tool half to rotate relative to the second tool half around the first bolt.

8. The unlocking tool of claim 7, wherein a pivot hole rotatably mating with a smooth rod portion of the first bolt is formed in the first horizontal plate, and a first threaded hole threadably connecting with a threaded portion of the first bolt is formed in the second horizontal plate.

9. The unlocking tool of claim 8, further comprising a first nut provided on an outer side of the second horizontal plate facing away from the first horizontal plate, a head of the first bolt is pressed against an outer side of the first horizontal plate facing away from the second horizontal plate, an end of the first bolt is exposed from the outer side of the second horizontal plate and threaded with the first nut.

10. The unlocking tool of claim 8, wherein a limit hole that is elongate is formed in the first horizontal plate, and a second threaded hole is formed in the second horizontal plate.

11. The unlocking tool of claim 10, further comprising a second bolt passing through the limit hole and threaded with the second threaded hole, the second bolt is movable between two ends of the limit hole, allowing the first tool half to rotate relative to the second tool half within a predetermined angle range.

12. The unlocking tool of claim 11, wherein when the first tool half and the second tool half are opened, an inner wall surface of one end of the limit hole is pressed against the second bolt to restrict the first tool half and the second tool half to a predetermined open position.

13. The unlocking tool of claim 12, wherein when the first tool half and the second tool half are in the predetermined open position, an opening angle between the first tool half and the second tool half is not greater than 20 degrees.

14. The unlocking tool of claim 10, wherein the limit hole is between the first end plate and the pivot hole, and the second threaded hole is between the second end plate and the first threaded hole.

15. The unlocking tool of claim 11, further comprising a second nut provided on an outer side of the second horizontal plate facing away from the first horizontal plate, a head of the second bolt is pressed against the outer side of the first horizontal plate facing away from the second horizontal plate, and an end of the second bolt is exposed from the outer side of the second horizontal plate and threaded with the second nut.

16. The unlocking tool of claim 12, further comprising a reset torsion spring installed between the first mounting portion and the second mounting portion, the reset torsion spring resets the first tool half and the second tool half to the predetermined open position.

17. The unlocking tool of claim 16, wherein the first mounting portion further includes a first vertical plate connected to one side of the first horizontal plate and the first end plate, and the second mounting portion further includes a second vertical plate connected to one side of the second horizontal plate and the second end plate, the first vertical plate and the second vertical plate are spaced apart and opposite to each other, a spiral body of the reset torsion spring is fitted onto the first bolt and between the first horizontal plate and the second horizontal plate, two torsion arms of the reset torsion spring each rest on an inner side of one of the first vertical plate and the second vertical plate.

18. A method for unplugging a cable assembly, comprising:
providing an unlocking tool;
grasping the unlocking tool in an open position with one hand and moving it towards a cable of a cable assembly, so that the cable enters between a first half cylinder and a second half cylinder of the unlocking tool;
grasping a first connecting portion and a second connecting portion of the unlocking tool tightly with one hand, so that the unlocking tool is rotated from the open position to a closed position;
inserting a cylindrical end portion of the unlocking tool into a mounting hole in a connector housing, so as to simultaneously push a plurality of locking springs inside the connector housing to an unlocking position separated from a terminal of the cable assembly through the cylindrical end portion; and
clamping a semi cylindrical body of the unlocking tool and the cable with one hand, and simultaneously pulling out the unlocking tool and the cable assembly outward to pull them out of the connector housing together.
